(19) United States
(12) Patent Application Publication
(10) Pub. No.: US 2012/0050028 A1
(43) Pub. Date: Mar. 1, 2012

(54) VEHICLE TEXT MESSAGING SYSTEM AND METHOD USING A METER CLUSTER DISPLAY

(75) Inventors: James MASTRONARDI, Canton, MI (US); Ryan RUMBERGER, Canton, MI (US); Michael MELDRUM, West Bloomfield, MI (US); Asako YOSHINAMI, Zama (JP); Deborah PIXLEY, Farmington Hills, MI (US)

(73) Assignee: NISSAN TECHNICAL CENTER NORTH AMERICA, INC., Farmington Hills, MI (US)

(21) Appl. No.: 12/870,111

(22) Filed: Aug. 27, 2010

(51) Int. Cl. B60Q 1/00

(52) U.S. Cl. 340/441; 340/425.5

(57) ABSTRACT

A method for presenting a new message received by a vehicle that includes a meter cluster display, an audio system, and an input device. The method includes receiving the new message at the vehicle, presenting a notification of the new message upon receipt of the new message by providing an audio alert via the audio system and displaying a visual notification on the meter cluster display, operating the meter cluster display to display a prompt for instructions to read the new message, operating the input device to receive the instructions to read the new message, and operating the audio system to audibly present the new message in accordance with the instructions.

### BACKGROUND

1. Field of the Invention

The present invention generally relates to a vehicle text messaging system and method. More specifically, the present invention relates to a vehicle text messaging system and method in which a text message is displayed in the meter cluster display of the vehicle and can also be audibly presented and acted upon.

2. Background Information

Text messaging on a mobile phone while driving is extremely dangerous as it distracts the driver from looking at the road to read and send text messages. While Bluetooth connectivity with mobile phones is becoming standard in vehicles, the typical functionality is limited to the use of making and receiving phone calls, but not necessarily text messaging. Most vehicle original equipment manufacturers (OEMs) that attempt to incorporate text messaging capabilities with the in-vehicle Bluetooth connection to mobile phones configure the systems to display the text message in some capacity on the primary navigation screen for reading, and require some text or voice input to create a message to be sent.

However, the use of the primary navigational display to manually read text messages still requires the driver to look away from the road, thus providing no additional safety benefit over traditional text messaging using the mobile phone. Some potential systems include a secondary display to show the text message, or an abbreviated view of the primary display, to communicate the message.

### SUMMARY

It has been discovered that it is more desirable for a system to require minimal reading by the driver so that the driver's eyes can remain focused on the road instead of on a display.

In view of the state of the known technology, one aspect of the present invention provides a method for presenting a new message received by a vehicle that includes a meter cluster display, an audio system, and an input device. The method comprises receiving the new message at the vehicle, presenting a notification of the new message upon receipt of the new message by providing an audio alert via the audio system and displaying a visual notification on the meter cluster display, operating the meter cluster display to display a prompt for instructions to read the new message, operating the input device to receive the instructions to read the new message, and operating the audio system to audibly present the new message in accordance with the instructions.

### BRIEF DESCRIPTION OF THE DRAWINGS

Referring now to the attached drawings which form a part of this original disclosure:

FIG. 1 is an exemplary view of the front of the passenger compartment of a vehicle employing a vehicle messaging system according to an embodiment of the present invention;

FIG. 2 is an exemplary view of the meter cluster of the passenger compartment shown in FIG. 1;

FIG. 3 is an exemplary block diagram of components of the vehicle messaging system employed in the vehicle;

FIG. 4 is a pictorial representation of an example of a function menu display that can be displayed by the vehicle messaging system;

FIG. 5 is a pictorial representation of an example of a phone function menu display that can be displayed by the vehicle messaging system;

FIGS. 6-8 are pictorial representations of examples of phone function settings displays, including an automatic response option, that can be displayed by the vehicle messaging system;

FIG. 9 is a flow chart illustrating an example of operations performed for presenting a new message in the vehicle whose passenger compartment is shown in FIG. 1;

FIG. 10 is a pictorial representation of an example of a new message notification screen;

FIG. 11 is a pictorial representation of another example of a new message notification screen;

FIG. 12 is a flow chart illustrating an example of operations performed for presenting options for new messages;

FIG. 13 is a pictorial representation of an example of a display showing options for responding to messages in accordance with the operations set forth in FIG. 12;

FIG. 14 is a flow chart illustrating an example of operations performed for the call back option in the flowchart of FIG. 12;

FIG. 15 is a flow chart illustrating an example of operations performed for the reply option in the flowchart of FIG. 12;

FIG. 16 is a pictorial representation of an example of a screen display showing examples of preprogrammed replies;

FIG. 17 is a flow chart illustrating an example of operations performed for presenting an error message;

FIG. 18 is a pictorial representation of an example of a screen display including examples of custom messages;

FIG. 19 is a flow chart illustrating an example of operations performed for the forward option in the flowchart of FIG. 12;

FIG. 20 is a flow chart illustrating an example of operations performed for the play again option in the flowchart of FIG. 12;

FIG. 21 is a flow chart illustrating an example of operations performed for the view option in the flowchart of FIG. 12;

FIG. 22 is a flow chart illustrating an example of operations performed for the save as custom option in the flowchart of FIG. 12;

FIG. 23 is a flow chart illustrating an example of operations performed according to an embodiment of the present invention for presenting a new message with an automatic reply option; and

FIG. 24 is a flow chart illustrating an example of operations performed according to an embodiment of the present invention for acting on a new or existing message.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

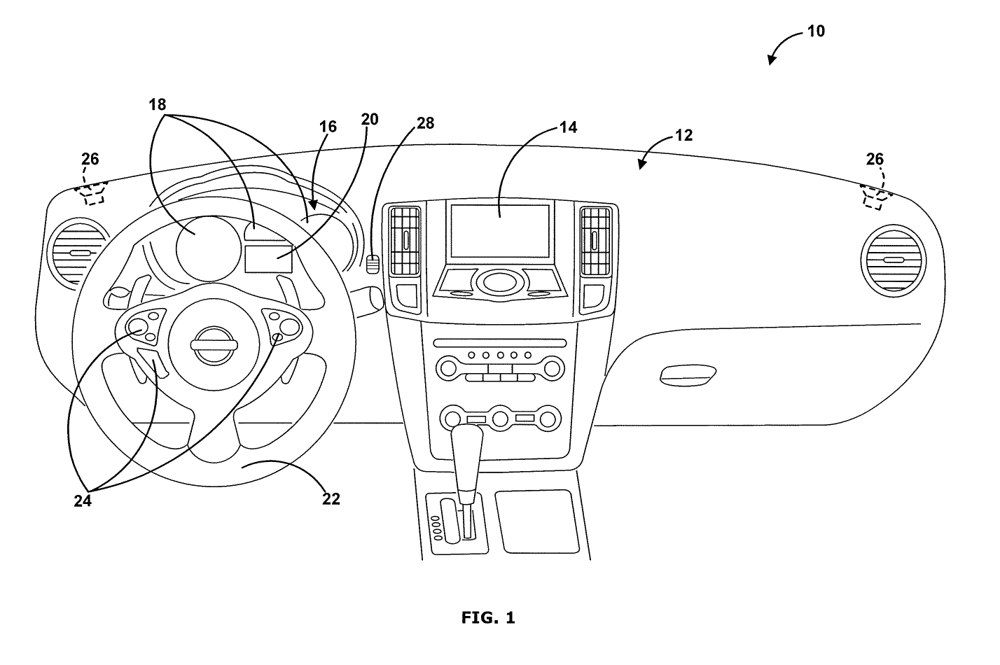

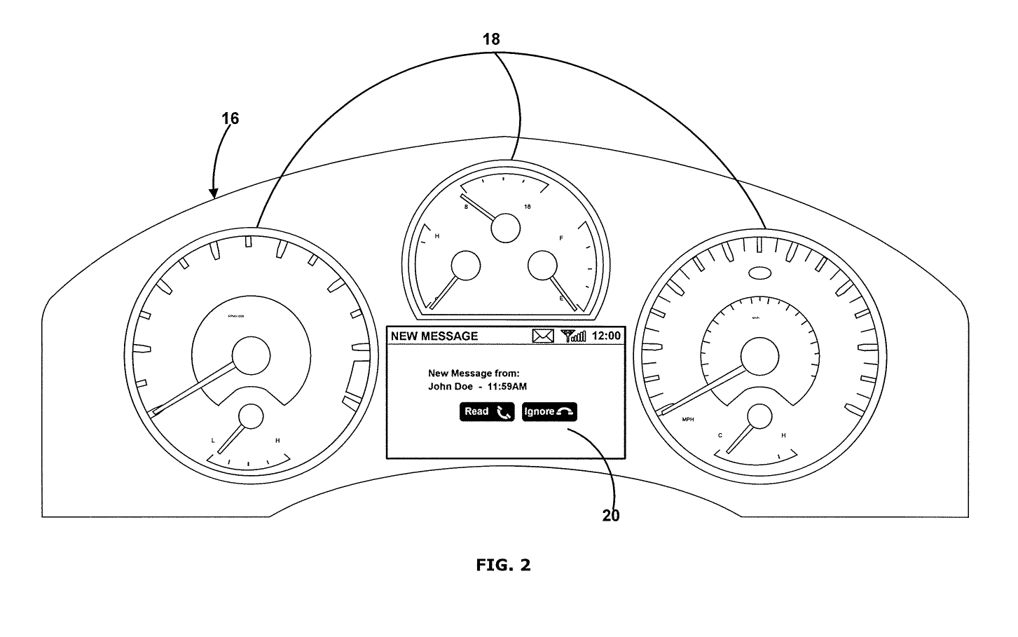

Referring initially to FIG. 1, a passenger compartment 10 of a vehicle employing an embodiment of the present invention is illustrated. The passenger compartment 10 includes an instrument panel 12 which, in this example, has a display 14, which is typically referred to as a primary display (but can also be referred to as a secondary display), and a meter cluster 16. Typically, the display 14 includes features for a navigation display and/or an audio system display. On the other hand, as shown in more detail in FIG. 2, the meter cluster 16 generally includes meters 18, such as a speedometer, tachometer and gauges. In this embodiment, the meter cluster 16 also includes a display 20, which can also be referred to as a meter cluster display 20 or secondary display (but can also be referred to as a primary display).

As further shown in FIG. 1, a steering wheel 22 extends from the instrument panel 12. The steering wheel 22 typically has steering wheel controls 24 as known in the art. In this example, the meter cluster 16 is directly aligned with the central longitudinal axis of the column of the steering wheel 22 and, in particular, the display 20 is directly aligned with or substantially aligned with the central longitudinal axis of the steering wheel column. However, the location of the meter cluster 16, as well as the positioning of the display 20 in the meter cluster 16, can be changed as deemed practical or desirable.

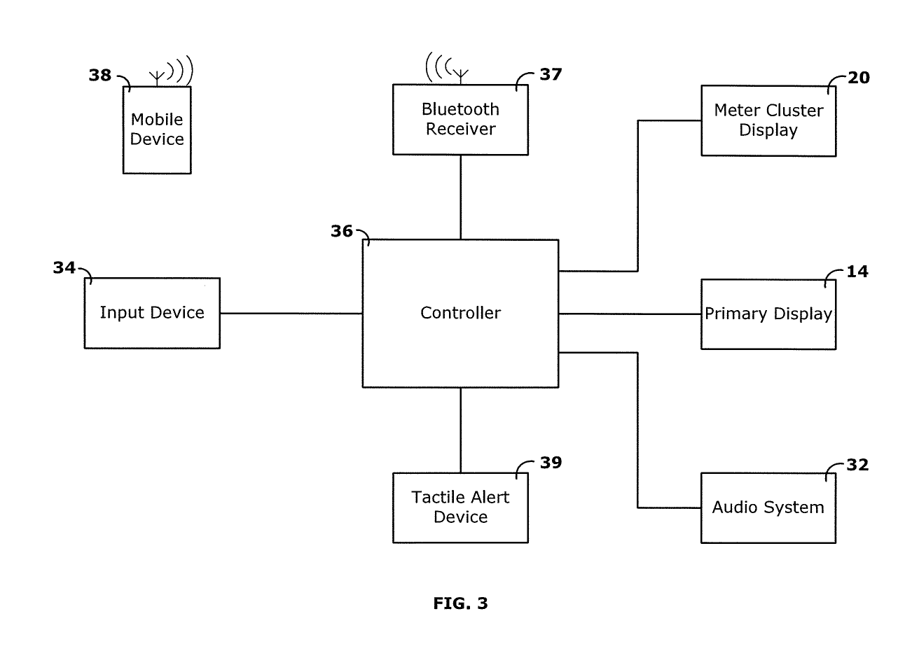

In addition, as shown in FIG. 1, typically two or more speakers 26 can be present in the instrument panel 12, or at any other suitable location in the vehicle. These speakers 26 can be used as radio speakers and to audibly output commands or messages from, for example, the navigation system of the vehicle, and from the vehicle messaging system 30 (FIG. 3) as discussed in more detail below. Also, a microphone 28 can be present in the instrument panel 12 or at any other suitable location in the vehicle, and can be used to receive voice commands for the telephone operations and for the vehicle messaging system 30 as discussed in more detail below.

FIG. 3 is an exemplary block diagram of components of a vehicle messaging system 30 according to an embodiment of the present invention, that is employed in the vehicle as discussed above. The vehicle messaging system 30 includes the meter cluster display 20, the display 14, an audio system 32, an input device 34 and a controller 36. The audio system 32 can include speakers 26 as discussed above. The input device 34 can include the microphone 28 and steering wheel controls 24 as discussed above, as well as any other suitable devices for providing input or commands to be used by the controller 36. Hence, the operating of the input device 34 as described herein includes operating the input device 34 to receive instructions as audible input via the microphone 28. Also, the operating the input device 34 as described herein includes operating the input device 34 to receive the instructions as manual input via manipulation of a manual control device, such as the steering wheel controls 24. It should be noted that the terms “select,” “selecting” and so on as used herein refer to the use of the input device 34, or any other suitable control device, that enables the user to make the selection (e.g., to select a displayed button).

The vehicle messaging system 30 can also include, or work in cooperation with, components that allow for hands-free telephone operation in the vehicle as known in the art. For example, the vehicle messaging system 30 can include a Bluetooth receiver 37 that can synchronize with a wireless telephone 38 to allow for hands-free telephone operation in the vehicle as understood in the art. The vehicle messaging system 30 can also include a tactile alert device 39 as discussed in more detail below. The speakers 26, microphone 28, audio system 32, input device 34, Bluetooth receiver 37, telephone 38 and tactile alert device 39 include conventional components that are well known in the art and will not be discussed or illustrated in detail herein. Rather, it will be apparent to those skilled in the art from this disclosure that the components can be any type of structure and/or programming that can be used to carry out the operations of the embodiments of the present invention described herein.

As discussed in more detail below, the controller 36 is configured to receive a new message, control notification of the new message upon receipt of the new message by controlling the audio system 32 to provide an audio alert and controlling the meter cluster display 20 to display a visual notification, control the meter cluster display 20 to prompt for instructions to read the new message, accept the instructions to read the new message via the input device 34, and control the audio system 32 to audibly present the new message in response to the instructions. As understood by one skilled in the art, the controller 36 preferably includes a microcomputer with a control program that controls the vehicle messaging system 30 as discussed herein. The controller 36 can also include other conventional components such as an input interface circuit, an output interface circuit, and storage devices such as a ROM (Read Only Memory) device and a RAM (Random Access Memory) device. The RAM and ROM store processing results and control programs that are run by the controller 36. The controller 36 is operatively coupled to the components of the vehicle messaging system 30, and to the components of the vehicle as appropriate, in a conventional manner. It will be apparent to those skilled in the art from this disclosure that the precise structure and algorithms for the controller 36 can be any combination of hardware and software that will carry out the functions of the present invention.

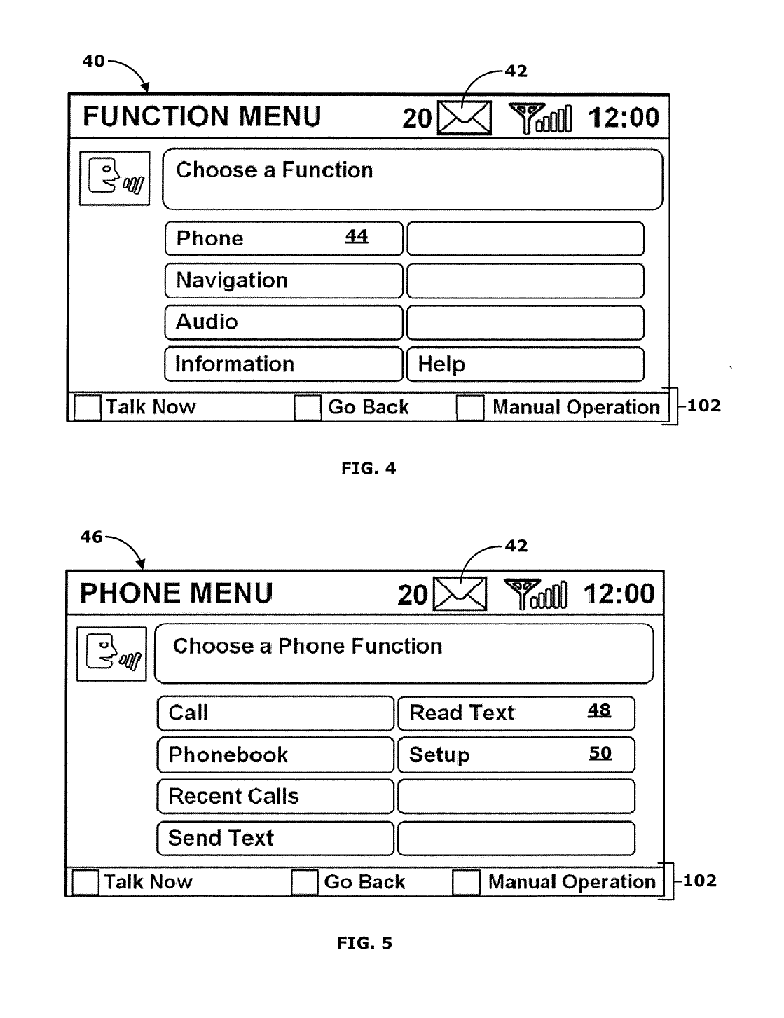

Before discussing further details of examples of the operations performed by the vehicle messaging system 30 to receive and act on messages, certain set up operations will now be discussed. For example, a user can operate the input device 34 to instruct the vehicle messaging system 30 to display a function menu screen 40 on, for example, the display 14 or on the meter cluster display 20. As shown in FIG. 4, the function menu screen 40 can include a new message indication 42, which is discussed in more detail below, and other information such as an indication of the signal strength of the receiver (e.g., a wireless telephone) and the time of day.

The function menu screen 40 also includes buttons which enable a user to select a device or feature to be accessed. For example, the user can select the phone button 44 to instruct the vehicle messaging system 30 to display a phone menu screen 46 as shown in FIG. 5 on the display 14 or the meter cluster display 20. The phone menu screen 46 includes various buttons which enable the user to select various telephone functions. These buttons include a read text button 48, which enables a user to access the text of an incoming or stored message as discussed in more detail below, and a setup button 50 which enables the user to access certain setup features. The function menu screen 40 and phone menu screen 46 also include operation buttons 102 as discussed in more detail below with regard to FIG. 13.

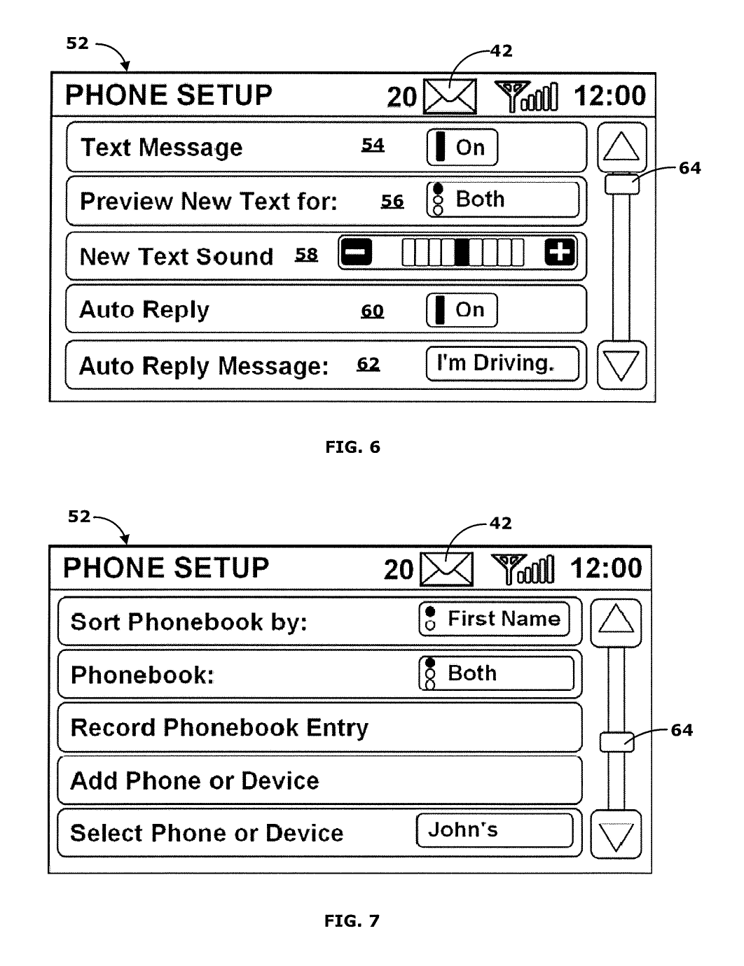

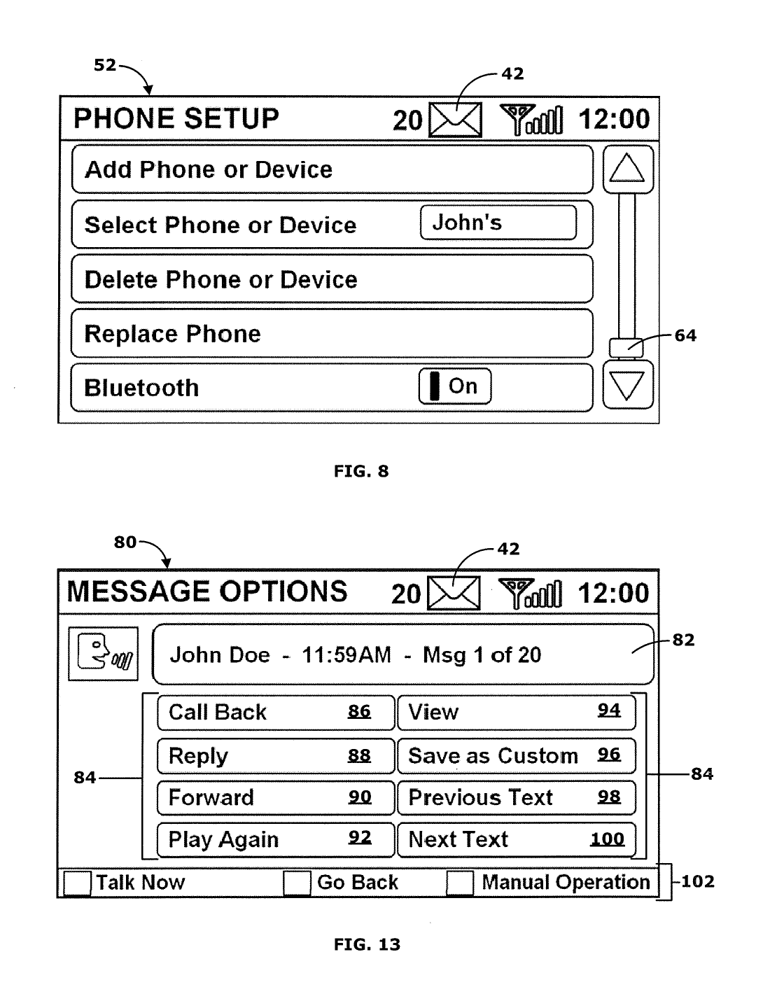

When the user selects the setup button 50, the vehicle messaging system 30 can display a phone setup screen 52 as shown in FIG. 6 on the display 14 or the meter cluster display 20. The phone setup screen 52 includes buttons, such as a text message function on/off button 54 that enables the user to turn text messaging functionality on or off. A preview new text button 56 enables the user to select whether a text message, such as a newly received text message, should not be displayed (the “none” option), should be displayed on the meter cluster display 20 only (the “driver” or “private” option) or should be displayed on both the display 14 and meter cluster display 20 (the “both” option). A new text sound button 58 enables the user to set the volume for a new message audio alert that the vehicle messaging system 30 presents upon receipt of a new text message. An auto reply button 60 enables the user to turn on or off the automatic reply features which are discussed in more detail below. Also, the auto reply message button 62 enables the user to select the auto reply message to be sent (e.g., “I'm driving”). The user can scroll the scroll bar 64 to access additional phone setup features as shown in FIGS. 7 and 8 which can be conventional features and are not discussed in further detail herein.

Further details of examples of the operations performed by the vehicle messaging system 30 will now be discussed. It should also be noted that for purposes of this discussion, when the vehicle messaging system 30 is described as providing a visual display, menu screen, prompt, notification, etc., the vehicle messaging system 30 can display such a visual display, menu screen, prompt or notification, etc. on the display 14, the meter cluster display 20, or both.

FIG. 9 is a flow chart illustrating an example of operations performed according to an embodiment of the present invention for presenting a new message in the vehicle whose passenger compartment 10 is shown in FIG. 1. As indicated, when the operation starts in step S100, the processing remains idle in step S102 while the controller 36 monitors for a new incoming message. If it is determined in step S104 that there is no new incoming message, then the processing returns to step S102 and repeats as indicated. However, if it is determined in step S104 that there is a new incoming message, the processing proceeds to step S106 and the vehicle messaging system 30 receives the message. As understood in the art, the message can be any type of message, such as a short messaging service (SMS) message, multimedia messaging service (MMS) message, a message from an application on a portable computer, personal data assistant (PDA), or handheld device such as a smart phone, and email, to name a few, that is typically formatted for transmission and receipt via wireless communications.

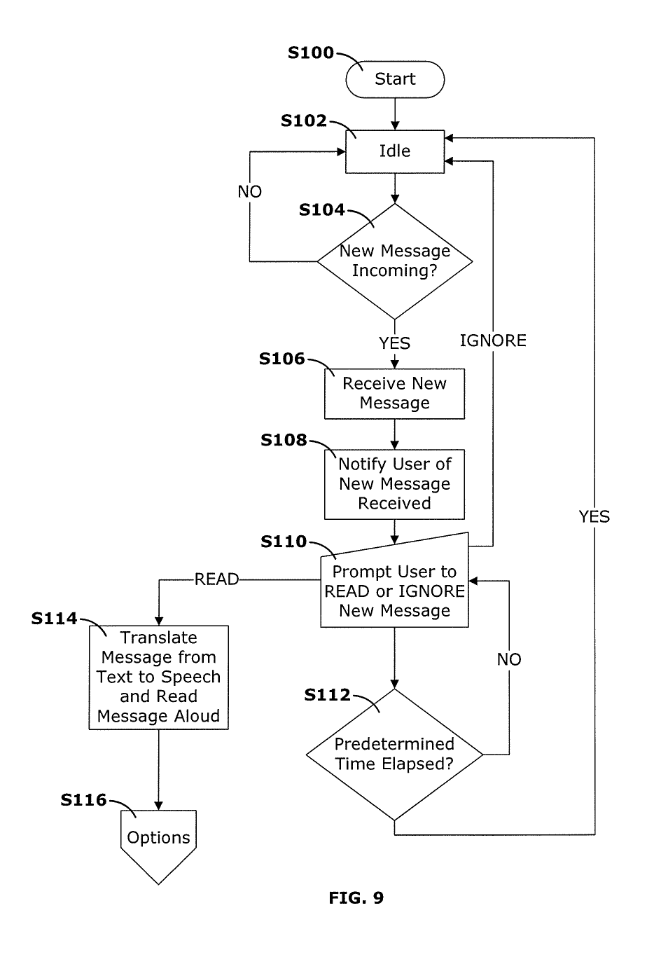

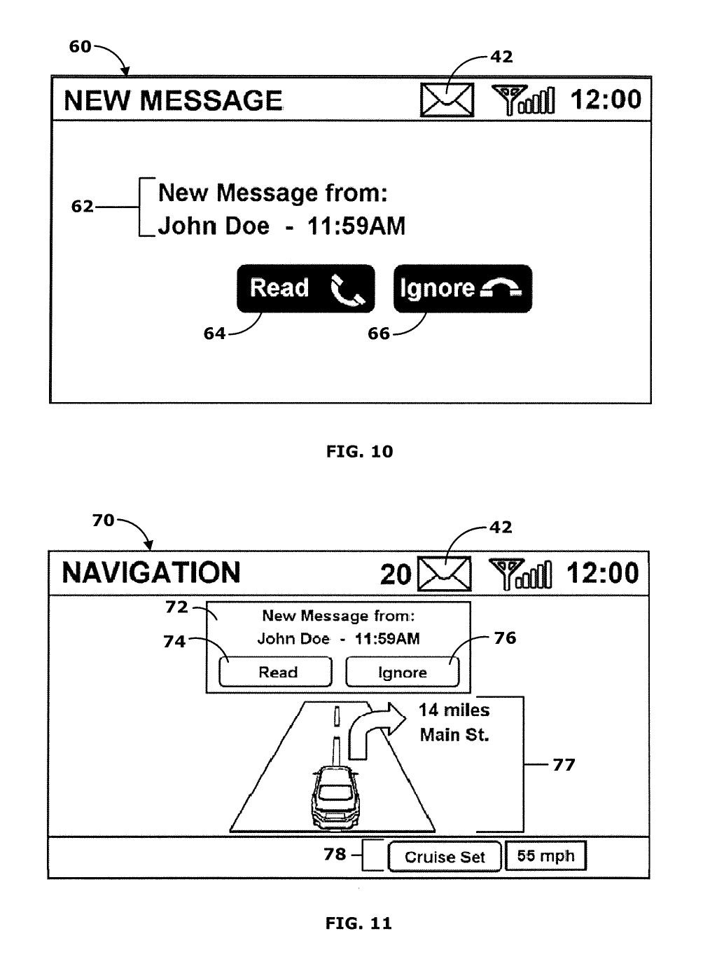

Once the vehicle messaging system 30 has received the incoming message, the controller 36 controls the vehicle messaging system 30 to provide a notification of the received incoming message in step S108. For example, the controller 36 can control the audio system 32 (e.g., the speakers 26) to provide an audio alert, and can control the meter cluster display 20 to display a visual notification such as that shown, for example, in FIG. 10. That is, the meter cluster display 20 can display a new message screen 60 that includes a new message indication 42 as mentioned above with regard to FIGS. 4-8, and a new message notification 62. Also, it should be understood that for the new message indication 42, and for any of the notifications or alerts described herein, the vehicle messaging system 30 can provide tactile feedback, such as a vibration to the driver's seat and/or the steering wheel, by operating the tactile alert device 39 as shown in FIG. 3 and as understood in the art. Furthermore, in step S110, the new message screen 60 further can prompt the user to read or ignore the message by displaying a read button 64 that a user (e.g., the driver) can select using the input device 34 to read the new message, and an ignore button 66 that the user can select using the input device 34 to ignore the new message. Alternatively, or in addition, the meter cluster display 20 can display a new message indication 42, a pop-up new message notification 72, a read button 74 and an ignore button 76 in the foreground of an informational screen 70 as shown in FIG. 11.

That is, meter cluster display 20 can act as a primary display if desired or, for example, in the absence of display 14, so that the meter cluster display 20 displays information such as navigational instructions 77 and vehicle condition information 78 (e.g., cruise control status, mileage, etc.). Pop-up new message notifications 72 are preferred when the meter cluster display 20 is used to relay some higher priority information, such as the navigational instructions 77 or vehicle condition information 78 which can still be viewed in the background. Other information (e.g., lower priority information), such as weather, currently playing music information, radio and media manipulation and so on, can also be displayed. To ensure the higher priority information is still visible in the background, the pop-up new message notifications 72 are preferably sized to be no more than 15% or about 15% of the usable display space of the meter cluster display 20, and positioned such that only a minimal portion, or preferably none, of the higher priority information is covered by the pop-up new message notification 72. For purposes of example, the following description will refer to the buttons on new message screen 60. However, similar functionality can be achieved using the corresponding buttons on the pop-up new message notification 72. Furthermore, as mentioned above, when the private mode has been selected, only the meter cluster display 20 displays the new message notification 62 or pop-up new message notification 72 and any text relating to the message, as discussed below.

If the user selects the ignore button 66, the processing returns to the idle mode in step S102 and waits for a new incoming message. Also, new message notification 62 including the read button 64 and ignore button 66 are displayed for a predetermined amount of time, preferably 10 seconds (or any other suitable length of time that can be selected by the user during the set-up operation), which is monitored in step S112. If it is determined in step S112 that the predetermined amount of time has elapsed before the user has selected the read button 64 or the ignore button 66, the processing returns to the idle mode in step S102 and waits for a new incoming message. This operation of returning to an idle state includes clearing the visual notification 62 and prompt (read button 64 and ignore button 66) from the meter cluster display 20, after the predetermined amount of time has elapsed from when the new message was received.

However, if it is determined in step S110 that the user has selected the read button 64 before the predetermined period of time has elapsed, then the processing proceeds to step S114. In step S114, the controller 36 controls the vehicle messaging system 30 to translate the message from text to speech using any typical translation software or programming, and controls the audio system 32 to audibly present the message, so that the occupants of the vehicle can hear the message. In addition, this reading operation can include operating the meter cluster display 20 to display a first portion of the new message, and operating the display 14, that is separate from the meter cluster display 20, to display a second portion of the new message which is larger than the first portion of the new message. In other words, the meter cluster display 20 can display the information pertaining to the sender as shown, for example, in FIG. 10. The meter cluster display 20 may also show the beginning portion of the text message, and the display 14 can display the remainder of the text message. The processing then proceeds to step S116, during which various options can be presented for the user.

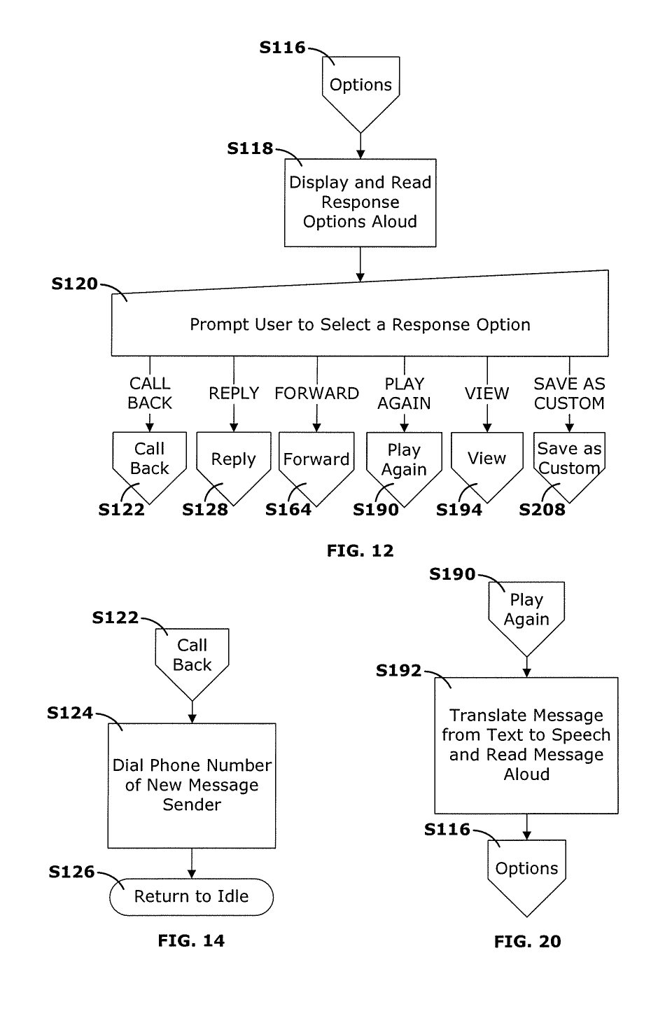

As shown in FIG. 12, options for new messages are presented in step S118. Specifically, a plurality of options to respond to the new message can be presented upon finishing audibly presenting the new message, and prompting for input to select one of the options occurs. That is, the controller 36 can control the display 14, the meter cluster display 20, or both, to display a message options screen 80 as shown in FIG. 13. The controller 36 can also control the audio system 32 to audibly present the response options. As shown in FIG. 13, the message options screen 80 includes a new message indication 42 as discussed above, and a current message information bar 82 that includes information pertaining to the received messages, including the newly received message. This information can identify the sender of the message and the time that the message was received.

The message option screen 80 further includes options buttons 84. These options buttons 84 include a call back button 86 that enables a user to call back the sender of the message, a reply button 88 that enables the user to send a reply message to the sender, a forward button 90 that enables the user to forward the message to another intended recipient, and a play again button 92 that enables the user to control the audio system 32 to again audibly present the message. The options buttons 84 further include a view button 94 that enables the user to view the message in its entirety, and a save as custom button 96 that enables the user to save the message as a custom message as discussed in more detail below. In addition, the options buttons 84 further include a previous text button 98 and a next text button 100 that enables a user to navigate through the received messages. That is, the user can scroll through the received text messages using the previous text button 98 and next text button 100. Hence, if the user is viewing message 1 (e.g., the most recently received message) out of 20 received messages, the user can select the next text button 100 to display the information pertaining to message 20 of 20 in the current message information bar 82, and the user can select the previous text button 98 to display the information pertaining to message 2 of 20 in the current message information bar 82. Naturally, the previous text button 98 and next text button 100 can be configured to scroll through the messages in any practical order. Once the desired message is displayed in the current message information bar 82, the user can use the other options buttons 84 to perform the desired operation on that displayed message.

Furthermore, the message option screen includes operation buttons 102. The user can select an appropriate one of these operation buttons 102 to, for example, switch to a “talk now” mode which enables the user to input instructions via microphone 28, to “go back” to a previous display screen on, for example, the meter cluster display 20 (or the display 14 as appropriate), or to switch to a “manual operation” that enables a user to input instructions via the steering wheel controls 24 instead of the microphone 28.

Turning back to FIG. 12, in step S120, the vehicle messaging system prompts the user, via a visual prompt, an audible prompt, or both, to selection one of the options buttons 54. If a call back option is selected, the processing proceeds to step S122, which begins the process shown in FIG. 14. As shown in step S124 of FIG. 14, the controller 36 controls the vehicle messaging system 30 and related components to call the sender of the received message and allow for hands-free telephone operations which use features of the audio system 32 (e.g., speakers 26) and the input device 34 (e.g., the microphone 28) as understood in the art. The processing then continues to step S126, where the processing returns to the idle step S102 in FIG. 9.

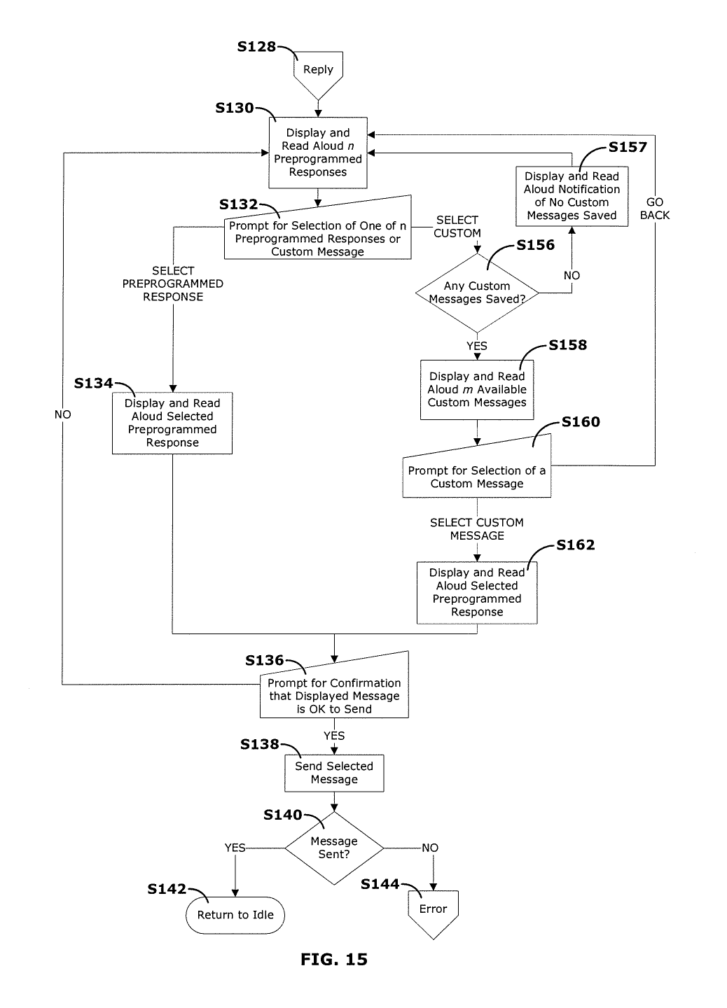

Alternatively, if a reply option is selected in step S120 of FIG. 12, the processing proceeds to step S128 which begins the processing shown in FIG. 15. As shown in step S130 of FIG. 15, the controller 36 controls the vehicle messaging system 30 to display and audibly present the preprogrammed responses. That is, as will now be described, the presenting a reply to the new message option includes presenting a plurality of preprogrammed replies by operating the display 14, the meter cluster display 20, or both, to display visual information representing each of the preprogrammed replies, and operating the audio system 32 to audibly present each of the preprogrammed replies, in response to selection of the reply to the new message option. Furthermore, the presenting a reply to the new message option includes presenting a custom message by operating the display 14, the meter cluster display 20, or both, to display visual information representing the custom message and operating the audio system to audibly present the custom message.

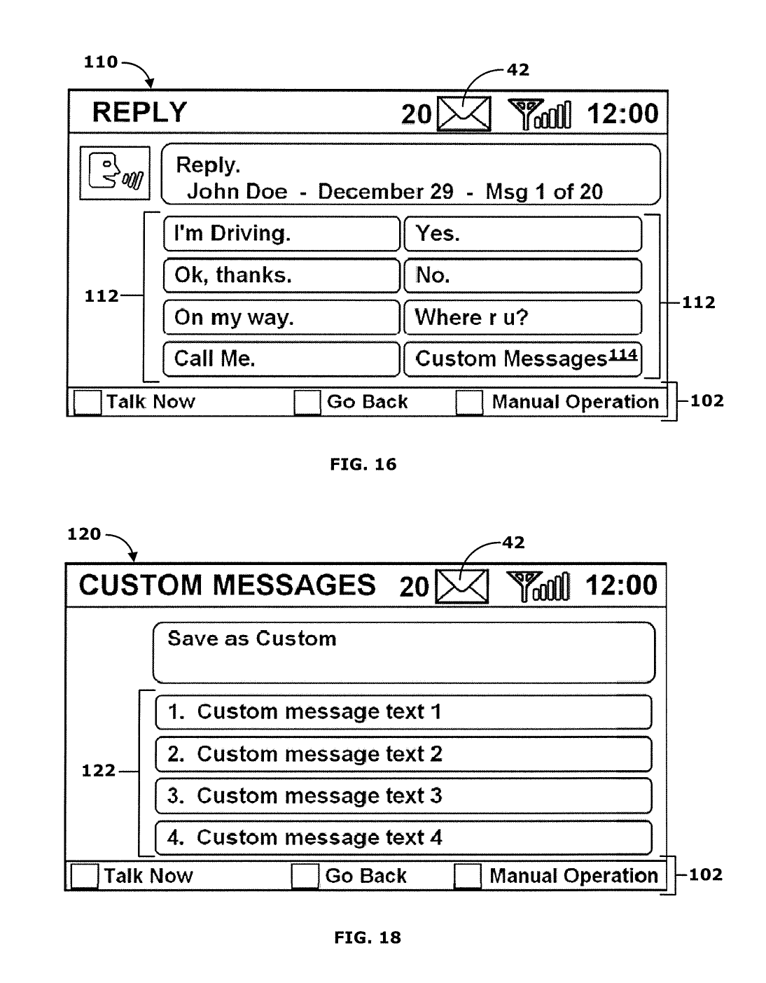

FIG. 16 illustrates a preprogrammed reply screen 110 including the preprogrammed replies 112 that display 14 and/or the meter cluster display 20 displays and which the audio system 32 audibly presents. The preprogrammed reply screen 110 further includes a custom messages button 114 that can be selected, and operation buttons 102 as discussed above.

The processing determines in step S132 whether one of the preprogrammed replies 112 or the custom messages button 114 has been selected. If one of the preprogrammed replies 112 has been selected, the processing controls the vehicle messaging system 30 to display and audibly present the selected preprogrammed response in step S134. In step S136, the processing then prompts the user, via a visual prompt, an audible prompt, or both, to confirm that the displayed preprogrammed response should be sent. If not, the processing returns to step S130 and repeats as discussed above. However, if the displayed preprogrammed response is confirmed, the vehicle messaging system 30 sends the selected preprogrammed response to the intended recipient in step S138, which in this case is the sender of the new incoming message that was received and acted upon as discussed above.

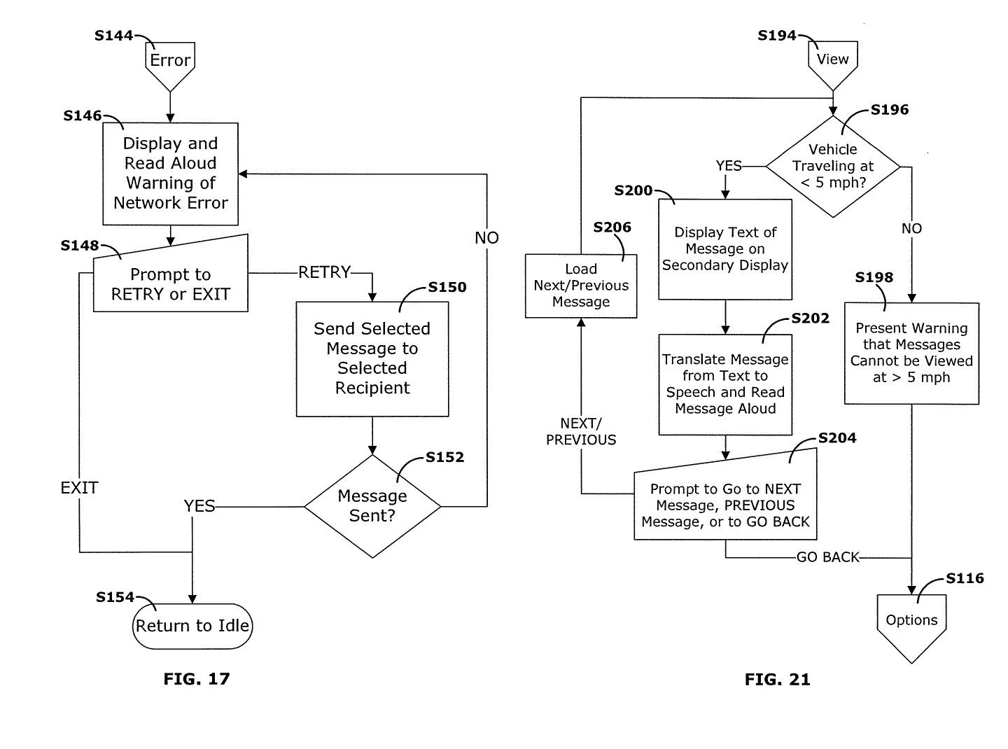

The processing then determines in step S140 if the selected preprogrammed response was sent. If the response was sent, the processing continues to step S142 and returns to the idle step S102 in FIG. 9. However, if the response was not sent, the processing continues to step S144 which begins the error processing shown in FIG. 17.

That is, in step S146 as shown in FIG. 17, the vehicle messaging system 30 visually and audibly presents a warning message indicating that there was a messaging error. In step S148, the vehicle messaging system 30 presents a visual prompt, an audible prompt, or both, to retry sending the selected response or to exit the reply process. If the retry prompt is selected, the vehicle messaging system 30 resends the selected response in step 150. The processing then determines in step S152 whether the message has been sent. If the message has not been sent, the processing returns to step S146 where the warning message is presented and the processing is repeated as discussed above. However, if the message has been sent, the processing continues to step S154 and returns to the idle step S102 in FIG. 9. Also, if the exit prompt is selected in step S148, the processing bypasses steps S150 and S152 and proceeds to step S154, where the processing returns to the idle step S102 in FIG. 9.

Turning back to FIG. 15, if the custom messages button 114 was selected in step S132 instead of a preprogrammed response, the processing continues to step S156. Hence, as will now be described, upon selection of the reply to the new message option, a custom message can be presented by operating the display 14, the meter cluster display 20, or both, to display visual information representing the custom message and operating the audio system 32 to audibly present the custom message.

In step S156, it is determined whether any custom messages are saved. If no custom messages are saved, the processing proceeds to step S157 during which a notification indicating that there are no custom messages is displayed on, for example, the meter cluster display 20. The processing then returns to step S130 and repeats as discussed above. However, if at least one custom message has been saved, the processing continues to step S158, during which the vehicle messaging system 30 visually and audibly presents the available custom messages. FIG. 18 illustrates an example of a custom messages menu display 120, including custom message slots 122 and corresponding text that are displayed on the display 14, the meter cluster display 20, or both. The custom message menu display 120 also includes a new message indication 42 and operation buttons 102 as discussed above.

In step S160, the processing then prompts the user, via a visual prompt, an audible prompt, or both, to select one of the custom messages. If the user decides not to send a custom message, the user can select the go back menu button from the operation buttons 102, and the processing returns to step S130 and repeats as discussed above. However, if a custom message is selected, the processing controls the vehicle messaging system 30 to display and audibly present the selected custom message in step S162. The processing then continues to step S136 and continues as discussed above.

That is, in step S136, the vehicle messaging system 30 then prompts the user, via a visual prompt, an audible prompt, or both, to confirm that the displayed custom message should be sent. If not, the processing returns to step S130 and repeats as discussed above. However, if the displayed custom message is confirmed, the vehicle messaging system 30 sends the selected custom message to the intended recipient, which in this case is the sender of the new incoming message that was received and acted upon as discussed above.

The processing then determines in step S140 if the selected custom message was sent. If the message was sent, the processing continues to step S142 and returns to the idle step S102 in FIG. 9. However, if the message was not sent, the processing continues to step S144 which begins the error processing shown in FIG. 17 as discussed above.

Accordingly, to summarize the operations for replying with a custom message, operations for receiving a custom message and saving the custom message may have been performed prior to the new message being received. The operations discussed above with regard to FIGS. 9 and 15 are performed for receiving a new message and presenting a notification of the new message upon receipt of the new message by providing an audio alert via the audio system and displaying a visual notification. In this case, the visual notification can be on the display 14, which can be considered a secondary display. Naturally, the visual notification can instead or in addition be displayed on the meter cluster display 20. The process includes operating the meter cluster display 20 to display a prompt for instructions to read the new message, operating the input device 34 to receive the instructions to read the new message, and operating the audio system 32 to audibly present the new message in accordance with the instructions. The process further includes operating the display 14 or the meter cluster display 20 to display a reply to the new message option, operating the display 14 or the meter cluster display 20 to display the custom message, and operating the audio system 32 to audibly present the custom message, upon selection of the reply to the new message option. The processing also includes operating the display 14 or the meter cluster display 20 to display a prompt for selection of the custom message, and sending the custom message in response to the new message upon selection of the custom message via the input device 34.

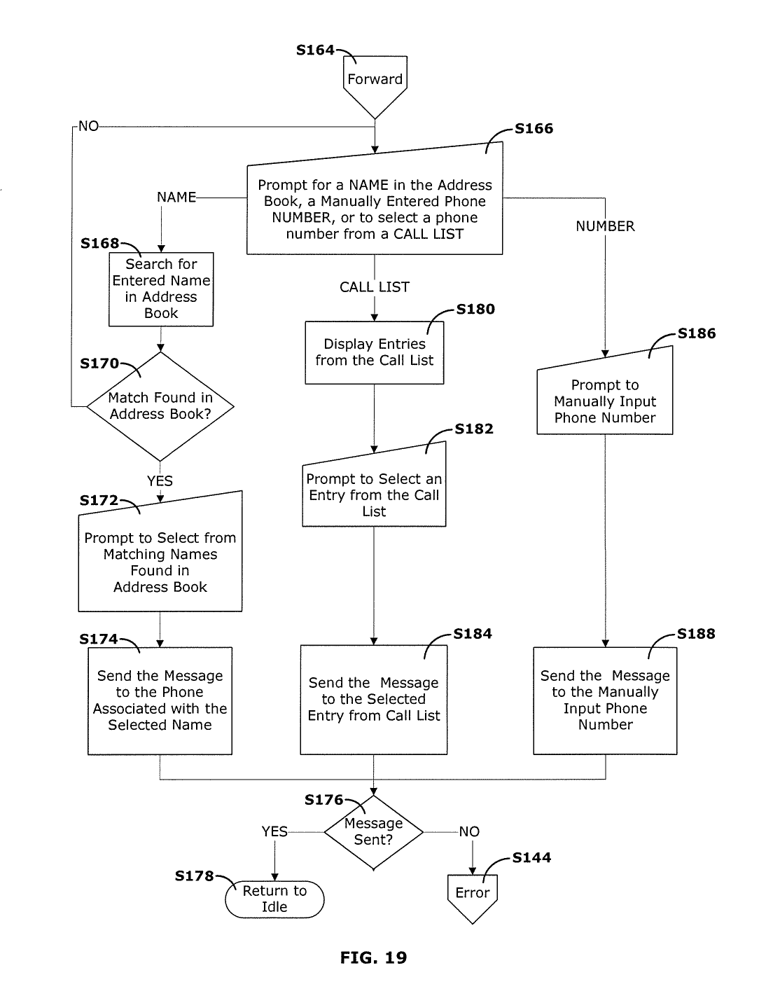

Turning back to FIG. 12, if a message forward option is selected in step S120, the processing proceeds to step S164 which begins the processing shown in FIG. 19. As shown in step S166 in FIG. 19, the vehicle messaging system 30 then prompts the user, via a visual prompt, an audible prompt, or both, to search for a name in the address book, select a phone number from a call list, or manually enter a phone number. If the user selects to search for a name in the address book, the processing continues to step S168 during which the vehicle messaging system 30 searches a stored address book for a name that can be entered by the user via, for example, the input device 34.

If it is determined in step S170 that no matching name has been found in the address book, the processing returns to step S166 and repeats as discussed above. However, if the desired name is found, the vehicle messaging system 30 then prompts the user, via a visual prompt, an audible prompt, or both, to select from the matching names in step S172. Once a name has been selected, the vehicle messaging system 30 forwards the received message to the phone associated with the selected name in step S174. Then, in step S176, if it is determined that the message has been forwarded, the processing continues to step S178, and returns to the idle step S102 in FIG. 9. However, if the message has not been forwarded, the processing continues to the error processing beginning in step S144 of FIG. 17 as discussed above.

If the user selects to select a phone number from a call list in step S166, the processing continues to step S180 during which the vehicle messaging system 30 displays entries from the call list, which can include, for example, incoming, outgoing, and missed calls, on the display 14 or the meter cluster display 20. Then, in step S182, the vehicle messaging system 30 prompts the user, via a visual prompt, an audible prompt, or both, to select an entry from the call list. Once the entry has been selected, the vehicle messaging system 30 forwards the received message to the phone associated with the selected entry in step S184. Then, in step S176, if it is determined that the message has been forwarded, the processing continues to step S178, and returns to the idle step S102 in FIG. 9. However, if the message has not been forwarded, the processing continues to the error processing beginning in step S144 of FIG. 17 as discussed above.

If the user selects to manually enter a phone number in step S166, the processing continues to step S186 during which the vehicle messaging system 30 prompts the user, via a visual prompt, an audible prompt, or both, to enter the phone number in step S186. Once the phone number has been entered, the vehicle messaging system 30 forwards the received message to the phone associated with the entered phone number in step S188. Then, in step S176, if it is determined that the message has been forwarded, the processing continues to step S178, and returns to the idle step S102 in FIG. 9. However, if the message has not been forwarded, the processing continues to the error processing beginning in step S144 of FIG. 17 as discussed above.

As shown in FIG. 12, if the play again option is selected in step S120, the processing proceeds to step S190 which begins the processing shown in FIG. 20. That is, in step S192, the vehicle messaging system 30 translates the message from text to speech and controls the audio system 32 to audibly present the message. The processing then returns to the options step S116 in FIG. 12.

If the view option is selected in step S120 of FIG. 12, the processing continues to step S194 which begins the processing shown in FIG. 21. That is, as will now be described, the presenting a plurality of options includes presenting a view the new message option as one of the plurality of options. This includes detecting whether a safety condition of the vehicle exists, and operating the meter cluster display 20 to display information representing at least a portion of the new message upon selection of the view the new message option and detection that the safety condition exists.

In step S196 in FIG. 21, it is determined whether the vehicle is traveling below a threshold value (e.g., 5 mph) as the safety condition. If the vehicle is not traveling below the threshold, in step S198 the vehicle messaging system 30 presents a visual message, an audible message, or both stating that the message cannot be displayed. The processing then returns to the options step S116 in FIG. 12.

However, if it is determined in step S196 that the vehicle is traveling below the threshold, the vehicle messaging system 30 displays the text of the message in the display 14 or the meter cluster display 20 in step S200. That is, the detecting of whether the safety condition exists includes detecting whether a speed of the vehicle is less than a predetermined speed (the threshold value), and indicting that the safety condition exists when the speed is less than the predetermined speed.

Then, in step S202, the vehicle messaging system 30 translates the message from text to speech and controls the audio system 32 to audibly present the message. In step S204, the vehicle messaging system 30 then prompts the user, via a visual prompt, an audible prompt, or both, to go to the next message, the previous message or to go back to the previous display. If the user selects to go to the next or previous message, the vehicle messaging system 30 loads the next or previous message, as appropriate, in step S206, returns to step S196 and repeats the processing discussed above for that next or previous message. However, if the user selects to go back in step S204, the processing returns to the options step S116 in FIG. 12.

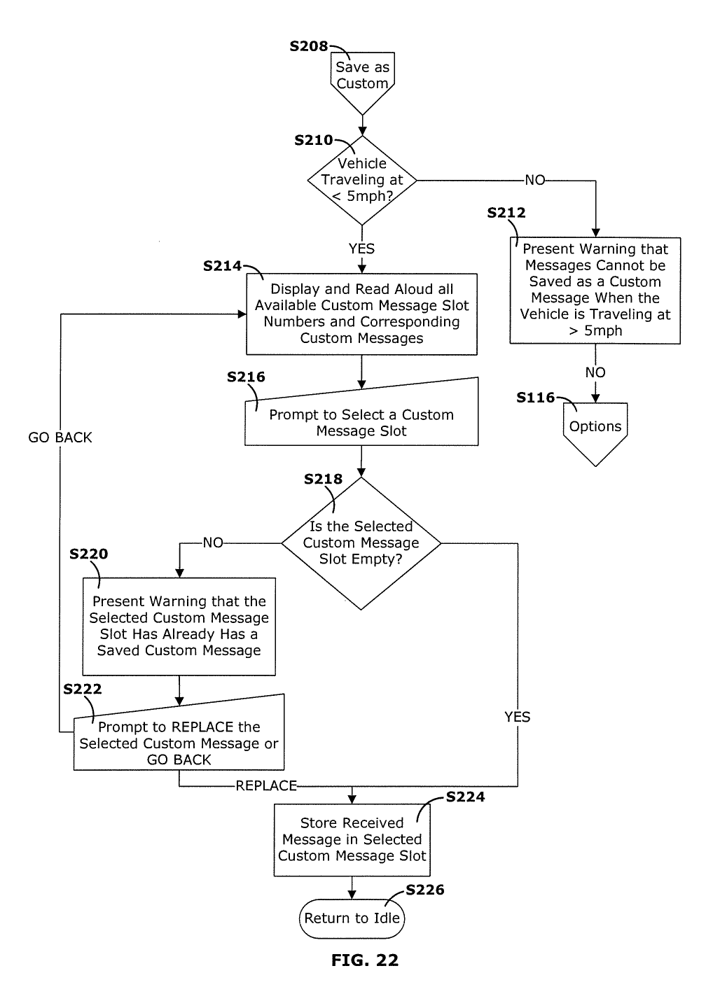

If the save as custom option is selected in step S120 in FIG. 12, the processing continues to step S208 which begins the processing shown in FIG. 22. Hence, the presenting a plurality of options includes presenting a save the new message option as one of the plurality of options, such that the new message can be saved as a custom message upon selection of the save the new message option. It should be understood that this custom message saving process could be performed to save a custom message that is used in the custom message reply operations discussed above with regard to FIG. 15.

In step S210 in FIG. 22, it is determined whether the vehicle is traveling below a threshold value (e.g., 5 mph) as the safety condition. If the vehicle is not traveling below the threshold, in step S212 the vehicle messaging system 30 presents a visual message, an audible message, or both stating that the message cannot be saved. The processing then returns to the options step S116 in FIG. 12.

However, if it is determined in step S210 that the vehicle is traveling below the threshold, the processing proceeds to step S214. In step S214, the vehicle messaging system 30 displays, on the display 14 or the meter cluster display 20, for example, the available custom message slot numbers in a custom message menu 120 as shown in FIG. 18 discussed above. The vehicle messaging system 30 can also audibly present the available custom message slot numbers. In step S216, the vehicle messaging system 30 prompts the user, via a visual prompt, an audible prompt, or both, to select a custom message slot. It is then determined in step S218 whether the selected custom message slot is empty. That is, operations for receiving a custom message and saving the custom message may have been performed prior to the new message being received, so that one or more custom messages may already have been saved in certain custom message slots. Hence, if the selected custom message slot is not empty, in step S220 the vehicle messaging system 30 presents a warning via a visible message, an audible message, or both, indicating that the selected custom message slot is not empty.

In step S222, the vehicle messaging system 30 prompts the user, via a visual prompt, an audible prompt, or both, to replace the selected custom message or go back. If the user selects to go back, the processing returns to step S214 and repeats as discussed above. However, if the user chooses to replace the message, the vehicle messaging system 30 stores the received message in the selected custom message slot in step S224. The processing then continues to step S226 and returns to the idle step in Step S102 of FIG. 9. Also, if it is determined in step S218 that the selected custom message slot is indeed empty, the processing proceeds from step S218 to step S224 where the vehicle messaging system 30 stores the received message in the selected custom message slot in step S224. Accordingly, the saving the custom message includes presenting a plurality of custom message slots, prompting for input via the input device to select one of the custom message slots, and saving the custom message to the selected custom message slot upon selection of the custom message slot via the input device. The processing then continues to step S226 and returns to the idle step in Step S102 of FIG. 9.

It should be noted that the process described above with regard to FIG. 22 preferably enables a user to send a message to the user's own telephone, and then save that message as a custom message. That is, if the user wishes to enter a custom message into the vehicle messaging system 30, the user can send that message to the user's own telephone. Upon receiving the message, the user can then select the save as custom option and proceed as discussed above to save that message as a custom message. Alternatively, the user can use, for example, the steering wheel controls 24, or the microphone 28 and voice-recognition processing as discussed above, to enter the desired text of the custom message during, for example, the set up process as discussed above with regard to FIGS. 4-8.

It should be further noted that since the view and save as custom options discussed above determine whether the safety condition exists before proceeding, the options processing beginning at step S116 can prevent the user from selecting those options if the safety condition does not exist. That is, in step S118, for example, the processing can determine whether the safety condition exists (e.g., whether the vehicle is traveling at below 5 mph). If the safety condition does not exist, the processing in step S118 can omit reading the view and save as custom options, and can, for example, display those options in a grayed-out manner, thus indicating that those options are not available at that time.

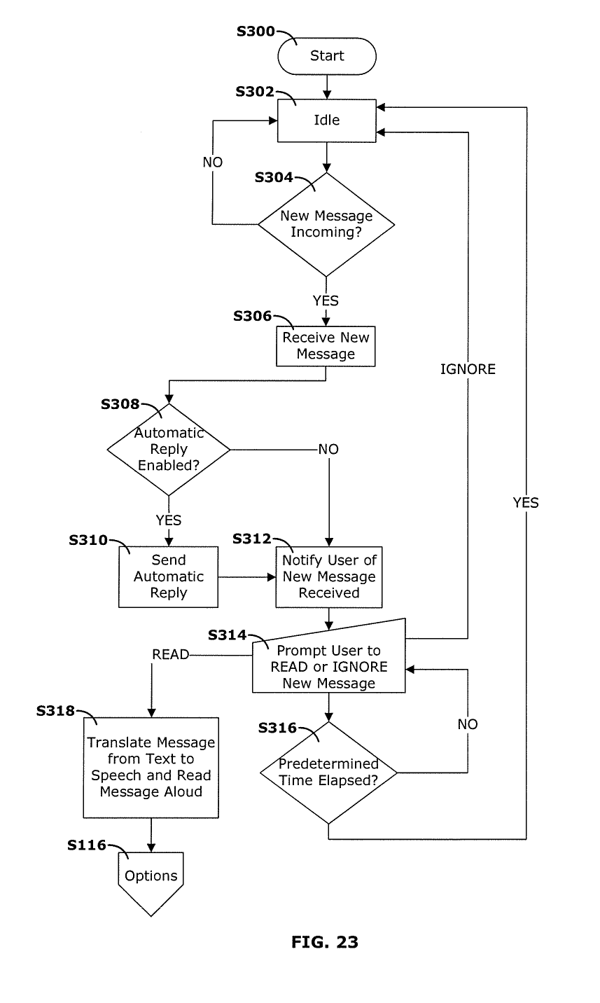

FIG. 23 is a flow chart illustrating an example of operations performed similar to those shown in FIG. 9, but further including an automatic reply feature. Hence, the operations include responding to the new message by automatically sending a preprogrammed reply upon receiving the new message.

As indicated, when the operation starts in step S300, the processing remains idle in step S302 while the controller 36 monitors for a new incoming message. If it is determined in step S304 that there is no new incoming message, then the processing returns to step S302 and repeats as indicated. However, if it is determined in step S304 that there is a new incoming message, the processing proceeds to step S306 and the vehicle messaging system 30 receives the message. As understood in the art, the message can be any type of message, such as a short messaging service (SMS) message, multimedia messaging service (MMS) message, an application, and email, to name a few, that is typically formatted for transmission and receipt via wireless communications.

Once the vehicle messaging system 30 has received the incoming message, the vehicle messaging system 30 determines in step 5308 whether the automatic reply feature has been enabled. If the automatic reply feature has been enabled, the vehicle messaging system 30 can display an indicator at, for example, a location proximate to new message indication 42 (see, e.g., FIGS. 10 and 11), which indicates that the automatic reply feature has been enabled. When the automatic reply feature is enabled, the vehicle messaging system 30 sends an automatic reply message to the intended recipient (i.e., the sender of the received message) in step S310. The automatic reply message can be any suitable message (e.g., “I'm driving”) that is configured by the user as discussed above with regard to FIG. 6. Hence, the process includes selecting, from a plurality of preprogrammed replies, the preprogrammed reply to be automatically sent by the responding operation.

After step S310, or if it is determined in step S308 that the automatic reply feature has not been enabled, the processing then continues to step S312, during which the controller 36 controls the vehicle messaging system 30 to provide a notification of the received incoming message. For example, the controller 36 can control the audio system 32 (e.g., the speakers 26) to provide an audio alert, and can control the meter cluster display 20, the display 14, or both, to display a visual notification such as that shown, for example, in FIG. 10. Alternatively, or in addition, a pop-up visual notification 72 such as that shown in FIG. 11 can be displayed on the meter cluster display 20. For purposes of this discussion, the display on the meter cluster display 20 will be described.

That is, the meter cluster display 20, the display 14, or both, can display a new message screen 60 (FIG. 10) that includes a new message indication 42 and a new message notification 62. Furthermore, in step S314, the new message screen 60 further can prompt the user to read or ignore the message by displaying a read button 64 that a user (e.g., the driver) can select using the input device 34 to read the new message, and an ignore button 66 that the user can select using the input device 34 to ignore the new message.

If the user selects the ignore button 66, the processing returns to the idle mode in step S302 and waits for a new incoming message. Also, the read button 64 and ignore button 66 are displayed for a predetermined period of time, which is monitored in step S316. If it is determined in step S316 that the predetermined period of time has elapsed before the user has selected the read button 64 or the ignore button 66, the processing returns to the idle mode in step S302 and waits for a new incoming message.

However, if it is determined in step S314 that the user has selected the read button 46 before the predetermined period of time has elapsed, then the processing proceeds to step S318. In step S318, the controller 36 controls the vehicle messaging system 30 to translate the message from text to speech using any typical translation software or programming, and controls the audio system 32 to audibly present the message, so that the occupants of the vehicle can hear the message. The processing then proceeds to step S116 in FIG. 12, during which various options can be presented for the user as discussed above.

It should be further noted that if the automatic reply feature has been enabled, instead of displaying a new message screen 60 (FIG. 10) or pop-up visual notification 72 (FIG. 11) in step S312, the vehicle messaging system 30 can simply increase the count associated with the new message indication 42 (see, for example, FIGS. 10 and 11) and highlight the new message indication 42 to provide an indication that a new message has been received. In this event, the processing can return to step S116 instead of performing steps S312 through S318.

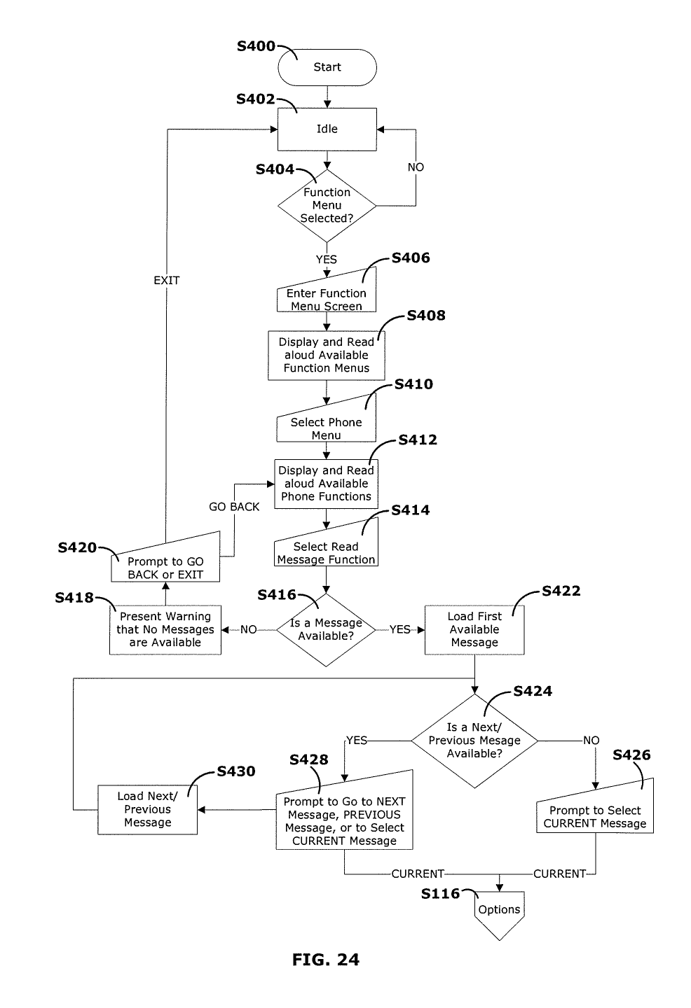

FIG. 24 is a flow chart illustrating an example of operations performed by the vehicle messaging system 30 for responding to an old message. Upon beginning in step S400, the vehicle messaging system 30 enters the idle phase in step S402. If it is determined in step S404 that the function menu has not been selected for display, the processing returns to step S402 and repeats. However, if the function menu has been selected for display, the processing continues to step S404 where the vehicle messaging system 30 displays the function menu screen 40 as shown, for example, in FIG. 4 discussed above. In step S406, the vehicle messaging system 30 displays and audibly presents the available function menus for the user to select.

In this example, the user selects the phone button 44 in step S408. Accordingly, in step S410, the vehicle messaging system 30 displays the phone menu display 46 as shown in FIG. 5 discussed above, and audibly presents the available phone functions. In this example, the user selects the read text button 48 in step S412. If it is determined in step S414 that no message is available, in step S416 the vehicle messaging system 30 present a visual and/or audible warning that no messages are available. In step S418, the vehicle messaging system 30 then prompts, via a visual prompt, audible prompt, or both, options to go back or exit. If the user selects the go back option, the processing returns to step S410 and repeats as discussed above. However, if the user selects the exit option, the processing returns to the idle step S402 and repeats as discussed above.

On the contrary, if it is determined in step S414 that a message is available, the processing loads the first available message as the message to be acted upon in step S420. In doing so, the vehicle messaging system 30 can display the message in, for example, the message option screen 80 as shown in FIG. 13 and discussed above. The processing also determines in step S422 whether any other messages are available. If not, the vehicle messaging system 30 then prompts a user, via a visual prompt, audible prompt, or both, to select the current message in step S424. If the user selects the current message, the processing continues to the options processing beginning at step S116 in FIG. 12, and proceeds as discussed above with regard to the selected current message.

However, if the processing determines in step S422 that other messages are available, the vehicle messaging system 30 then prompts a user, via a visual prompt, audible prompt, or both, to go to the next message or the previous message, or to select the current message, in step S426. If the user selects the next or previous message, the processing loads that selected message in step S428, returns to step S422, and continues as discussed above with the selected next or previous message being treated as the current message. However, if the user selects the current message in step S426, then processing continues to the options processing beginning at step S116 in FIG. 12, and proceeds as discussed above with regard to the selected current message.

Accordingly, as can be appreciated from the above, the embodiments of the present invention described herein utilize text-to-speech and the secondary display to minimize the interaction required by the driver to read and send text messages. The vehicle messaging system 30 provides the option to read or ignore a received text message on the secondary display. If the driver chooses to read the message, by manual or voice input, the vehicle messaging system 30 uses text-to-speech to read the message aloud, then provides the opportunity to respond. If the driver indicates the desire to respond, the vehicle messaging system 30 can provide a list of preprogrammed responses to choose from that can be read aloud by the system and selected by the user by voice. Additionally, the vehicle messaging system 30 can select which preprogrammed responses are available, select a preprogrammed response to respond automatically, and has the ability to save custom text message responses by sending a text message to, for example, the driver's own mobile phone while the phone is connected to the system, either physically or wirelessly.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. The term “configured” as used herein to describe a component, section or part of a device includes hardware and/or software that is constructed and/or programmed to carry out the desired function. The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A method for presenting a new message received by a vehicle that includes a meter cluster display, an audio system, and an input device, the method comprising:
receiving the new message at the vehicle;
presenting a notification of the new message upon receipt of the new message by providing an audio alert via the audio system and displaying a visual notification on the meter cluster display;
operating the meter cluster display to display a prompt for instructions to read the new message;
operating the input device to receive the instructions to read the new message; and
operating the audio system to audibly present the new message in accordance with the instructions.

2. The method according to claim 1, further comprising
presenting a plurality of options to respond to the new message upon finishing audibly presenting the new message; and
prompting for input to select one of the options.

3. The method according to claim 2, wherein
the presenting of a plurality of options includes presenting a reply to the new message option as one of the plurality of options.

4. The method according to claim 3, wherein
the presenting a reply to the new message option includes presenting a plurality of preprogrammed replies by operating the meter cluster display to display visual information representing each of the preprogrammed replies, and operating the audio system to audibly present each of the preprogrammed replies, in response to selection of the reply to the new message option.

5. The method according to claim 3, wherein
the presenting a reply to the new message option includes presenting a custom message by operating the meter cluster display to display visual information representing the custom message and operating the audio system to audibly present the custom message.

6. The method according to claim 2, wherein
the presenting a plurality of options includes presenting a save the new message option as one of the plurality of options.

7. The method according to claim 6, further comprising
saving the new message as a custom message upon selection of the save the new message option.

8. The method according to claim 7, wherein
the presenting a plurality of options includes presenting a reply to the new message option as one of the plurality of options, and upon selection of the reply to the new message option, presenting the custom message by operating the meter cluster display to display visual information representing the custom message and operating the audio system to audibly present the custom message.

9. The method according to claim 2, wherein
the presenting a plurality of options includes presenting a view the new message option as one of the plurality of options.

10. The method according to claim 9, further comprising
detecting whether a safety condition of the vehicle exists; and
operating the meter cluster display to display information representing at least a portion of the new message upon selection of the view the new message option and detection that the safety condition exists.

11. The method according to claim 10, wherein
the detecting includes detecting whether a speed of the vehicle is less than a predetermined speed, and indicting that the safety condition exists when the speed is less than the predetermined speed.

12. The method according to claim 1, further comprising
responding to the new message by automatically sending a preprogrammed reply upon receiving the new message.

13. The method according to claim 12, further comprising
selecting, from a plurality of preprogrammed replies, the preprogrammed reply to be automatically sent by the responding.

14. The method according to claim 1, further comprising
returning to an idle state, which includes clearing the visual notification and prompt from the meter cluster display, after a predetermined amount of time has elapsed from when the new message was received.

15. The method according to claim 1, wherein
the operating the input device includes operating the input device to receive the instructions as audible input via a microphone.

16. The method according to claim 1, wherein
the operating the input device includes operating the input device to receive the instructions as manual input via manipulation of a manual control device.

17. The method according to claim 1, further comprising
operating the meter cluster display to display a first portion of the new message.

18. The method according to claim 17, further comprising
operating a primary display, separate from the meter cluster display, to display second portion of the new message which is larger than the first portion of the new message.

19. The method according to claim 1, wherein
the presenting a notification further comprises presenting a tactile alert upon receipt of the new message.

20. A method for responding to a new message received in a vehicle that includes a meter cluster display, an audio system, and an input device, the method comprising:
receiving a custom message;
saving the custom message;
receiving a new message;
presenting a notification of the new message upon receipt of the new message by providing an audio alert via the audio system and displaying a visual notification on the meter cluster display;
prompting for instructions to read the new message;
operating the input device to receive the instructions to read the new message;
operating the audio system to audibly present the new message in accordance with the instructions;
presenting a reply to the new message option;
operating the audio system to audibly present the custom message, upon selection of the reply to the new message option;
prompting for selection of the custom message; and
sending the custom message in response to the new message upon selection of the custom message via the input device.

21. The method according to claim 20, wherein
the saving the custom message includes presenting a save option upon receipt of the custom message, and saving the custom message upon selection of the save option.

22. The method according to claim 20, wherein
the saving the custom message includes presenting a plurality of custom message slots, prompting for input via the input device to select one of the custom message slots, and saving the custom message to the selected custom message slot upon selection of the custom message slot via the input device.

23. A vehicle messaging system comprising:
a meter cluster display;
a primary display;
an audio system;
an input device; and
a controller configured to:
receive a new message;
control notification of the new message upon receipt of the new message by controlling the audio system to provide an audio alert and controlling the meter cluster display to display a visual notification;
control the meter cluster display to prompt for instructions to read the new message;
accept the instructions to read the new message via the input device; and
control the audio system to audibly present the new message in response to the instructions.
